(19) United States
(12) Patent Application Publication
(10) Pub. No.: US 2026/0046937 A1
(43) Pub. Date: Feb. 12, 2026

(54) ON-DEMAND RANDOM ACCESS CHANNEL PROCEDURE

(71) Applicant: QUALCOMM Incorporated, San Diego, CA (US)

(72) Inventor: Linhai HE, San Diego, CA (US)

(21) Appl. No.: 19/246,279

(22) Filed: Jun. 23, 2025

Related U.S. Application Data
(60) Provisional application No. 63/680,926, filed on Aug. 8, 2024.

(51) Int. Cl. H04W 74/0833

(52) U.S. Cl. CPC H04W 74/0833

(57) ABSTRACT

Methods, systems, and devices for wireless communication are described. A user equipment (UE) may request activation of a random access channel (RACH) configuration via an on-demand RACH procedure. The UE may receive a control message indicating that a network entity supports multiple random access channel (RACH) configurations. The UE may transmit a first message including a first identifier of a first RACH configuration of the multiple RACH configurations based on a trigger condition for requesting activation of the first RACH configuration being satisfied, the first RACH configuration being associated with a first RACH procedure. The UE may receive a response to the first message, the response including the first identifier of the first RACH configuration to indicate the activation of the first RACH configuration responsive to the first message including the first identifier of the first RACH configuration.

### CROSS REFERENCES

The present Application for Patent claims benefit of U.S. Provisional Patent Application No. 63/680,926 by Linhai HE, entitled “ON-DEMAND RANDOM ACCESS CHANNEL PROCEDURE,” filed Aug. 8, 2024, assigned to the assignee hereof, and expressly incorporated herein.

### FIELD OF TECHNOLOGY

The present disclosure relates to wireless communication, including on-demand random access channel (RACH) procedure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Wireless communications devices may perform random access channel (RACH) procedures. For example, a user equipment (UE) may perform a RACH procedure to request access to and establish a connection with a network entity.

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving a control message indicating that a network entity supports a set of multiple random access channel (RACH) configurations, transmitting a first message including a first identifier of a first RACH configuration of the set of multiple RACH configurations based on a trigger condition for requesting activation of the first RACH configuration being satisfied, the first RACH configuration being associated with a first RACH procedure, and receiving a response to the first message, the response including the first identifier of the first RACH configuration to indicate the activation of the first RACH configuration responsive to the first message including the first identifier of the first RACH configuration.

A UE for wireless communication is described. The UE may include one or more memories storing processor executable code, and one or more processors coupled with the one or more memories. The one or more processors may individually or collectively be operable to execute the code to cause the UE to receive a control message indicating that a network entity supports a set of multiple RACH configurations, transmit a first message including a first identifier of a first RACH configuration of the set of multiple RACH configurations based on a trigger condition for requesting activation of the first RACH configuration being satisfied, the first RACH configuration being associated with a first RACH procedure, and receive a response to the first message, the response including the first identifier of the first RACH configuration to indicate the activation of the first RACH configuration responsive to the first message including the first identifier of the first RACH configuration.

Another UE for wireless communication is described. The UE may include means for receiving a control message indicating that a network entity supports a set of multiple RACH configurations, means for transmitting a first message including a first identifier of a first RACH configuration of the set of multiple RACH configurations based on a trigger condition for requesting activation of the first RACH configuration being satisfied, the first RACH configuration being associated with a first RACH procedure, and means for receiving a response to the first message, the response including the first identifier of the first RACH configuration to indicate the activation of the first RACH configuration responsive to the first message including the first identifier of the first RACH configuration.

A non-transitory computer-readable medium storing code for wireless communication is described. The code may include instructions executable by one or more processors to receive a control message indicating that a network entity supports a set of multiple RACH configurations, transmit a first message including a first identifier of a first RACH configuration of the set of multiple RACH configurations based on a trigger condition for requesting activation of the first RACH configuration being satisfied, the first RACH configuration being associated with a first RACH procedure, and receive a response to the first message, the response including the first identifier of the first RACH configuration to indicate the activation of the first RACH configuration responsive to the first message including the first identifier of the first RACH configuration.

In some examples of the method, UEs, and non-transitory computer-readable medium described herein, the set of multiple RACH configurations include at least an on-demand RACH configuration, and where the first message, the response to the first message, or both may be communicated in accordance with an on-demand RACH procedure corresponding to the on-demand RACH configuration.

In some examples of the method, UEs, and non-transitory computer-readable medium described herein, the on-demand RACH configuration may be associated with a first physical RACH (PRACH) for on-demand random access and the first PRACH may be different than a second PRACH corresponding to a common RACH configuration of the set of multiple RACH configurations.

In some examples of the method, UEs, and non-transitory computer-readable medium described herein, the on-demand RACH configuration and a common RACH configuration of the set of multiple RACH configurations may be associated with a same PRACH, and the on-demand RACH configuration may be associated with different set of preambles, RACH occasions (ROs), or both than the common RACH configuration.

In some examples of the method, UEs, and non-transitory computer-readable medium described herein, transmitting the first message may include operations, features, means, or instructions for transmitting the first message including the first identifier of the first RACH configuration, where the first RACH configuration includes the common RACH configuration, the common RACH configuration being associated with a common RACH procedure.

In some examples of the method, UEs, and non-transitory computer-readable medium described herein, transmitting the first message may include operations, features, means, or instructions for transmitting the first message including the first identifier of the first RACH configuration, where the first RACH configuration includes the RACH configuration associated with the UE type, the RACH configuration being associated with a RACH procedure corresponding to the UE type.

In some examples of the method, UEs, and non-transitory computer-readable medium described herein, the first message indicates a preamble, a RO, or both, corresponding to the first RACH configuration.

In some examples of the method, UEs, and non-transitory computer-readable medium described herein, receiving the response to the first message may include operations, features, means, or instructions for receiving the response to the first message in a search space associated with an on-demand RACH procedure, and where the response may be scrambled via a common radio network temporary identifier (RNTI).

Some examples of the method, UEs, and non-transitory computer-readable medium described herein may further include operations, features, means, or instructions for transmitting a retransmission of the first message based on failure to receive the response to the first message within a random access response (RAR) window, where the response to the first message may be received based on the retransmission of the first message.

In some examples of the method, UEs, and non-transitory computer-readable medium described herein, receiving the response to the first message may include operations, features, means, or instructions for receiving the response including the first identifier of the first RACH configuration to indicate the activation of the first RACH configuration, where the first RACH configuration includes, prior to receiving the response, a deactivated RACH configuration of the one or more deactivated RACH configurations.

In some examples of the method, UEs, and non-transitory computer-readable medium described herein, the control message further includes an indication of a mapping of one or more RACH resources to respective RACH configurations of the set of multiple RACH configurations.

In some examples of the method, UEs, and non-transitory computer-readable medium described herein, the control message includes a system information block (SIB) message.

A method for wireless communication by a network entity is described. The method may include transmitting a control message indicating that the network entity supports a set of multiple RACH configurations, receiving a first message including a first identifier of a first RACH configuration of the set of multiple RACH configurations based on a trigger condition for requesting activation of the first RACH configuration being satisfied, the first RACH configuration being associated with a first RACH procedure, and transmitting a response to the first message, the response including the first identifier of the first RACH configuration to indicate the activation of the first RACH configuration responsive to the first message including the first identifier of the first RACH configuration.

A network entity for wireless communication is described. The network entity may include one or more memories storing processor executable code, and one or more processors coupled with the one or more memories. The one or more processors may individually or collectively be operable to execute the code to cause the network entity to transmit a control message indicating that the network entity supports a set of multiple RACH configurations, receive a first message including a first identifier of a first RACH configuration of the set of multiple RACH configurations based on a trigger condition for requesting activation of the first RACH configuration being satisfied, the first RACH configuration being associated with a first RACH procedure, and transmit a response to the first message, the response including the first identifier of the first RACH configuration to indicate the activation of the first RACH configuration responsive to the first message including the first identifier of the first RACH configuration.

Another network entity for wireless communication is described. The network entity may include means for transmitting a control message indicating that the network entity supports a set of multiple RACH configurations, means for receiving a first message including a first identifier of a first RACH configuration of the set of multiple RACH configurations based on a trigger condition for requesting activation of the first RACH configuration being satisfied, the first RACH configuration being associated with a first RACH procedure, and means for transmitting a response to the first message, the response including the first identifier of the first RACH configuration to indicate the activation of the first RACH configuration responsive to the first message including the first identifier of the first RACH configuration.

A non-transitory computer-readable medium storing code for wireless communication is described. The code may include instructions executable by one or more processors to transmit a control message indicating that the network entity supports a set of multiple RACH configurations, receive a first message including a first identifier of a first RACH configuration of the set of multiple RACH configurations based on a trigger condition for requesting activation of the first RACH configuration being satisfied, the first RACH configuration being associated with a first RACH procedure, and transmit a response to the first message, the response including the first identifier of the first RACH configuration to indicate the activation of the first RACH configuration responsive to the first message including the first identifier of the first RACH configuration.

In some examples of the method, network entities, and non-transitory computer-readable medium described herein, the set of multiple RACH configurations include at least an on-demand RACH configuration, and where the first message, the response to the first message, or both may be communicated in accordance with an on-demand RACH procedure corresponding to the on-demand RACH configuration.

In some examples of the method, network entities, and non-transitory computer-readable medium described herein, the on-demand RACH configuration may be associated with a first PRACH for on-demand random access and the first PRACH may be different than a second PRACH corresponding to a common RACH configuration of the set of multiple RACH configurations.

In some examples of the method, network entities, and non-transitory computer-readable medium described herein, the on-demand RACH configuration and a common RACH configuration of the set of multiple RACH configurations may be associated with a same PRACH, and the on-demand RACH configuration may be associated with different set of preambles, ROs, or both than the common RACH configuration.

In some examples of the method, network entities, and non-transitory computer-readable medium described herein, transmitting the response to the first message may include operations, features, means, or instructions for transmitting the response to the first message in a search space associated with an on-demand RACH procedure, and where the response may be scrambled via a common RNTI.

In some examples of the method, network entities, and non-transitory computer-readable medium described herein, transmitting the response to the first message may include operations, features, means, or instructions for transmitting the response including the first identifier of the first RACH configuration to indicate the activation of the first RACH configuration, where the first RACH configuration includes, prior to receiving the response, a deactivated RACH configuration of the one or more deactivated RACH configurations.

In some examples of the method, network entities, and non-transitory computer-readable medium described herein, the control message further includes an indication of a mapping of one or more RACH resources to respective RACH configurations of the set of multiple RACH configurations.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support on-demand random access channel (RACH) procedure in accordance with one or more aspects of the present disclosure.

FIG. 3 shows an example of a process flow that supports on-demand RACH procedure in accordance with one or more aspects of the present disclosure.

FIGS. 4 and 5 show block diagrams of devices that support on-demand RACH procedure in accordance with one or more aspects of the present disclosure.

FIG. 6 shows a block diagram of a communications manager that supports on-demand RACH procedure in accordance with one or more aspects of the present disclosure.

FIG. 7 shows a diagram of a system including a device that supports on-demand RACH procedure in accordance with one or more aspects of the present disclosure.

FIGS. 8 and 9 show block diagrams of devices that support on-demand RACH procedure in accordance with one or more aspects of the present disclosure.

FIG. 10 shows a block diagram of a communications manager that supports on-demand RACH procedure in accordance with one or more aspects of the present disclosure.

FIG. 11 shows a diagram of a system including a device that supports on-demand RACH procedure in accordance with one or more aspects of the present disclosure.

FIGS. 12 through 15 show flowcharts illustrating methods that support on-demand RACH procedure in accordance with one or more aspects of the present disclosure.

### DETAILED DESCRIPTION

In some wireless communications systems, wireless communications devices may perform random access channel (RACH) procedures based on a RACH configuration. For example, a network entity may indicate the RACH configuration in a system information block (SIB). Such RACH configurations may be referred to herein as fixed RACH configurations. The network entity may update the fixed RACH configurations via a system information update, such as in another SIB. However, such an updates may occur relatively infrequently. That is, updates to RACH configurations via SIBs may occur infrequently (e.g., on an order of multiple hours per update) relative to changes in a RACH access load of a wireless communications system. The network entity may be unable to address changes to the RACH access load in the wireless communications system based on transmission of the SIB being relatively infrequent. In such examples, a RACH resource utilization may be improved by implementing dynamic activation of RACH resources.

For example, as described herein, a wireless communications system may enable dynamic activation of one or more RACH resources via an on-demand RACH procedure. To support the on-demand RACH procedure, a network entity may advertise an on-demand RACH configuration corresponding to the on-demand RACH procedure. For example, the network entity may broadcast a SIB including an indication of the on-demand RACH configuration and multiple RACH configurations that may be activated in response to a request transmitted via the on-demand RACH procedure. A user equipment (UE) may identify or otherwise determine that a trigger condition for requesting a RACH configuration via the on-demand RACH procedure is satisfied and transmit a request for the RACH configuration. The request may include an identifier of the RACH configuration and one or more parameters associated with the RACH configuration, such as a preamble, a RACH occasion (RO), or both. The network entity may, in response to the request, transmit a message including the identifier of the RACH configuration confirming that the RACH configuration is activated. After communicating the message responding to the request, the network entity and the UE may perform a RACH procedure corresponding to the requested RACH configuration.

By requesting a RACH configuration via the on-demand RACH procedure, the wireless communications system may support improved RACH resource utilization compared to a fixed RACH configuration. The on-demand RACH procedure may additionally, or alternatively, support RACH partitioning. A network entity may partition RACH resources for each UE type or combination of UE types of UEs served by the network entity. In some cases, partitioned (e.g., hard partitioned) RACH configurations may support one or more features, including slicing. By using the on-demand RACH procedure to activate RACH configurations based on request, the network entity may more efficiently partition RACH resources based on one or more UE types performing RACH procedures. For example, UEs may request a RACH configuration associated with a UE type, which may indicate the UE type to the network entity to support partitioning of RACH resources. Additionally, the on-demand RACH procedure may support network energy saving, as a network entity may activate RACH configurations after receiving a request from a UE. For example, the on-demand RACH procedure may limit activated RACH configurations that are not in use by a UE. Accordingly, the network entity may refrain from monitoring the ROs associated with RACH configurations which are not activated, which may support network energy saving.

Aspects of the disclosure are initially described in the context of wireless communications systems. Aspects of the disclosure are further described with reference to a process flow. Aspects of the disclosure are further illustrated by and described with reference to apparatus diagrams, system diagrams, and flowcharts that relate to on-demand RACH procedure.

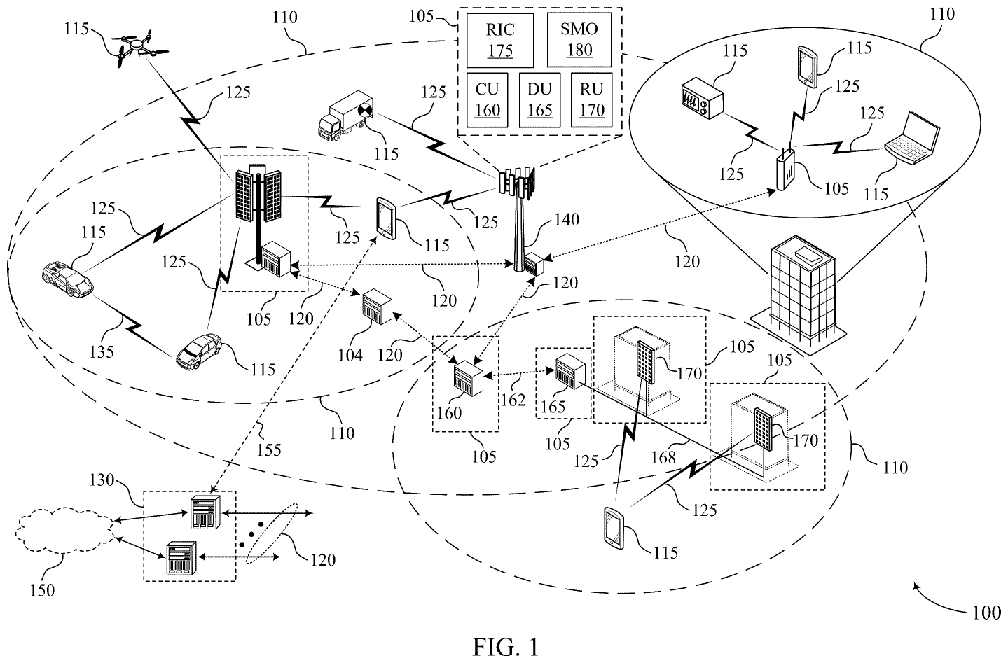

FIG. 1 shows an example of a wireless communications system 100 that supports on-demand RACH procedure in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As described herein, the wireless communications system 100 may enable dynamic activation of one or more RACH resources via an on-demand RACH procedure. To support the on-demand RACH procedure, the network entity 105 may advertise an on-demand RACH configuration corresponding to the on-demand RACH procedure. For example, the network entity 105 may transmit a control message indicating that the network entity 105 supports multiple RACH configurations that may be activated after request via the on-demand RACH procedure. The UE 115 may identify or otherwise determine that a trigger condition for requesting a RACH configuration via the on-demand RACH procedure is satisfied and transmit a request for the RACH configuration. For example, the UE 115 may transmit a first message including a first identifier of the RACH configuration based on the trigger condition for requesting activation of the RACH configuration being satisfied, where the RACH configuration is associated with a RACH procedure. The network entity 105 may, transmit a response to the first message including the identifier of the RACH configuration to indicate the activation of the RACH configuration responsive to the first message. After communicating the message responding to the request, the network entity 105 and the UE 115 may perform the RACH procedure corresponding to the requested RACH configuration.

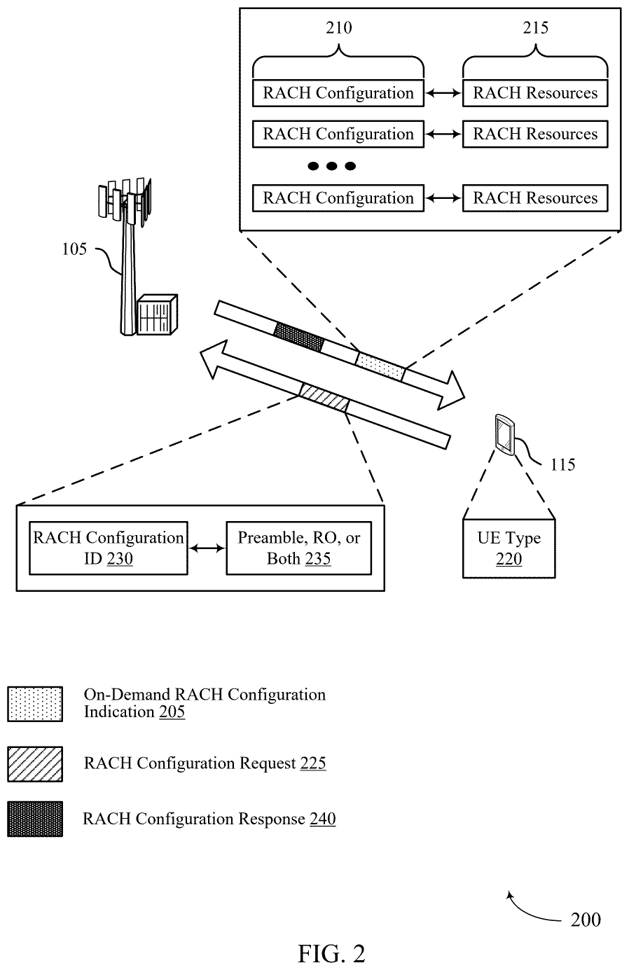

FIG. 2 shows an example of a wireless communications system 200 that supports on-demand RACH procedure in accordance with one or more aspects of the present disclosure. The wireless communications system 200 may implement or be implemented by various aspects of the wireless communications system 100. For example, the wireless communications system 200 may include a network entity 105 and a UE 115, which may represent examples of corresponding devices as described with reference to FIG. 1.

The network entity 105 may transmit an on-demand RACH configuration indication 205. The network entity 105 may include the on-demand RACH configuration indication 205 in a control message, such as in a SIB. For example, the network entity 105 may advertise the on-demand RACH configuration in the SIB (e.g., in SIB1). As discussed herein, the UE 115 may perform random access in two operations. A first operation may be where the UE 115 uses the on-demand RACH configuration to request a common RACH or a specific RACH configuration that the UE 115 is requesting to use. A second operation may be that, after confirmation of the requested RACH configuration, the UE 115 may perform a corresponding RACH procedure using the requested RACH configuration, as described herein.

The network entity 105 may configure the on-demand RACH configuration in a dedicated physical RACH (PRACH). For example, the on-demand RACH configuration may be associated with a first PRACH for on-demand random access, where the first PRACH is different than a second PRACH corresponding to a common RACH configuration. In some examples, the network entity 105 may configure the on-demand RACH configuration in the dedicated PRACH in examples in which the on-demand RACH configuration, but no other RACH configuration, is active. For example, the network entity 105 may configure the on-demand RACH configuration in the dedicated PRACH in examples in which one or more other RACH configurations, including a common RACH configuration, are deactivated. In such examples, the network entity 105 may save energy by monitoring fewer PRACHs. In some examples, the network entity 105 may configure the on-demand RACH configuration in a same PRACH as the common RACH configuration. In such examples, the on-demand RACH configuration may have a different set of preambles, ROs, or both than the common RACH configuration. That is, the network entity 105 may configure a first set of preambles, first ROs, or both for the on-demand RACH configuration that are different than a second set of preambles, second ROs, or both for the common RACH configuration.

The common RACH configuration, as used herein, may refer to a RACH configuration used by UEs having one or more RACH trigger conditions that are not associated with any of the set of RACH configurations 210. For example, a UE, such as the UE 115 may use the common RACH configuration in examples in which a RACH configuration associated with features of the UE 115 (e.g., a capability, RACH trigger conditions, etc.) is not included in the set of RACH configurations 210 (e.g., able to be activated or enabled, supported by the network entity 105, etc.). In some examples, a common RACH configuration may refer to a RACH configuration used by one or more UEs whose one or more RACH triggers do not qualify for using any other RACH configuration.

The on-demand RACH configuration indication 205 may include a set of one or more RACH configurations 210 that are deactivated and available by request. For example, the on-demand RACH configuration indication 205 may include the set of one or more RACH configurations 210 that are not currently active at a time of communication of the on-demand RACH configuration indication 205 (e.g., a time of transmission by the network entity 105, a time of receipt by the UE 115, etc.). The network entity 105 may advertise, via the SIB including the on-demand RACH configuration indication 205, that the set of one or more RACH configurations 210 may be enabled via the on-demand RACH procedure corresponding to the on-demand RACH configuration. A RACH configuration of the set of one or more RACH configurations 210 may include an indication of one or more time resources, one or more frequency resources, or both reserved for a RACH procedure corresponding to the RACH configuration. For example, the RACH configuration may include an indication of a slot reserved for the RACH procedure.

The on-demand RACH configuration indication 205 may include a mapping of one or more RACH resources 215 in the on-demand RACH configuration to one or more different RACH configurations in the set of one or more RACH configurations 210. As an example, the mapping may indicate that a first RACH configuration corresponds to one or more first RACH resources, a second RACH configuration corresponds to one or more second RACH resources, and so on. The one or more RACH resources may refer to a preamble, RO, or both. For example, each RACH configuration may correspond to a preamble (e.g., a preamble identifier, a preamble sequence, etc.) in a RO or an RO in a RACH configuration period.

That is, the first RACH configuration may correspond to a first preamble, the second RACH configuration may correspond to a second preamble, and so on. In such examples, a same RO may be shared by multiple RACH configurations of the set of RACH configurations 210 (e.g., corresponding to multiple UE types). As an example, one or more first RACH configurations may be mapped to a first RO, one or more second RACH configurations may be mapped to a second RO, and so on. In another example, each RACH configuration may correspond to an RO (e.g., a specific RO) in a RACH configuration period. As an example, a first RO may correspond to one or more first RACH configurations (e.g., a first, second, and third RACH configuration), a second RO may correspond to one or more second RACH configurations (e.g., a fourth, fifth, and sixth RACH configuration), and so on.

Additionally, or alternatively, each RACH configuration may correspond to a preamble and an RO. For example, a first RO may correspond to a first set of RACH configurations, where respective sets of preambles correspond to respective RACH configurations of the first set of RACH configurations. For example, a first set of preambles (e.g., preambles 1 -30) of the first RO may correspond to a first RACH configuration of the first set of RACH configurations, a second set of preambles (e.g., preambles 31 -60) of the first RO may correspond to a second RACH configuration of the first set of RACH configurations, and the remaining preambles (e.g., preambles 61 -64) of the first RO may correspond to a third RACH configuration of the first set of RACH configurations. That is, the network entity 105 may partition preambles within different ROs such that respective sets of RACH configurations mapped to the different ROs are further mapped to respective preambles within an RO.

The UE 115 may use the on-demand RACH procedure corresponding to the on-demand RACH configuration of the on-demand RACH configuration indication 205 advertised by the network entity 105 based on one or more trigger conditions. For example, the UE 115 may transmit a RACH configuration request 225 based on a trigger condition being satisfied. The one or more trigger conditions may be predefined at the UE 115. In some examples, the trigger condition may include availability of a common RACH configuration, availability of a RACH configuration associated with a UE type 220 of the UE 115, or both.

For example, a trigger condition may be satisfied based on a common RACH configuration being absent from one or more enabled (e.g., active, available, etc.) RACH configurations. Determining whether the trigger condition is satisfied may include determining whether the common RACH configuration was included in the SIB transmitted by the network entity 105. For example, the UE 115 may determine whether the SIB includes one or more parameters for common RACH. In examples in which the SIB does not include the one or more parameters for common RACH (e.g., common RACH is not activated), the common RACH configuration may be included in the set of RACH configurations 210 advertised by the network entity 105 via the on-demand RACH configuration indication 205 (e.g., via the SIB). The common RACH configuration may be available by request in accordance with being included in the set of RACH configurations 210 in the on-demand RACH configuration indication 205. The UE 115 may transmit the RACH configuration request 225 requesting activation of (e.g., configuration of) the common RACH configuration based on the trigger condition being satisfied.

In another example, the trigger condition may be satisfied based on a RACH configuration corresponding to a feature combination at the UE 115 being absent from one or more enabled (e.g., active, available, etc.) RACH configurations. For example, the trigger condition may be satisfied based on the UE 115 having a combination of features that triggered RACH not having a corresponding (e.g., matching) active RACH configuration (e.g., of RACH configurations advertised in a SIB by the network entity 105). That is, when a RACH configuration corresponding to the combination of features is triggered at the UE 115, the UE 115 may determine whether the triggered RACH configuration is included in the set of RACH configurations 210 advertised in the SIB including the on-demand RACH configuration indication 205. If the RACH configuration is included in the set of RACH configurations 210, the UE 115 may request activation of the RACH configuration by transmitting the RACH configuration request 225.

The feature combination may include the UE type 220 (e.g., a reduced capability (RedCap) UE). For example, the RACH configuration corresponding to the UE type 220 may be included in the set of RACH configurations 210 advertised by the network entity 105 via the on-demand RACH configuration indication 205 (e.g., via the SIB). For example, the RACH configuration corresponding to the UE type 220 may be included in the set of RACH configurations in the on-demand RACH configuration indication 205. The UE 115 may transmit the RACH configuration request 225 requesting activation of (e.g., configuration of) the common RACH configuration based on the trigger condition being satisfied.

After the trigger condition is satisfied, the UE 115 may select a preamble, RO, or both 235 for transmission of the RACH configuration request 225. For example, the UE 115 may select the preamble, the RO, or both 235 corresponding to the requested RACH configuration according to the mapping between RACH configurations and RACH resources in the on-demand RACH configuration indication 205. The UE 115 may include the RACH configuration identifier (ID) 230 and the selected preamble, RO, or both 235 in the RACH configuration request 225. The UE 115 may retransmit the RACH configuration request 225. For example, the UE 115 may retransmit the RACH configuration request 225 based on failing to receive a RACH configuration response 240 within a random access response (RAR) window. The SIB message (e.g., SIB1) including the on-demand RACH configuration indication 205 may further indicate the duration of the RAR window.

The network entity 105 may transmit a RACH configuration response 240 based on receiving the RACH configuration request 225 (e.g., initially or the retransmission). The RACH configuration response 240 may include the RACH configuration ID 230 of the requested RACH. In some examples, the network entity 105 may transmit the RACH configuration response 240 in a search space corresponding to (e.g., specific for) on-demand RACH. The SIB message (e.g., SIB1) including the on-demand RACH configuration indication 205 may further indicate the search space for on-demand RACH. In some examples, the network entity 105 may scramble the RACH configuration response 240 by a common radio network temporary identifier (RNTI) (e.g., instead of a random access RNTI (RA-RNTI)). The common RNTI may be an example of an RNTI known to all UEs (e.g., predefined, advertised in system information, etc., where the common RNTI may be specifically used for scrambling a response to an on-demand RACH request). For example, the network entity 105 may scramble the RACH configuration response 240 via the common RNTI such that one or more UEs different than the UE 115 (e.g., different than the UE that requested the RACH configuration) de-scramble or decode the RACH configuration response 240. In such examples, the one or more UEs may refrain from performing the on-demand RACH procedure to request activation of the RACH configuration, as the one or more UEs are notified of the activation of the RACH configuration via the RACH configuration response 240.

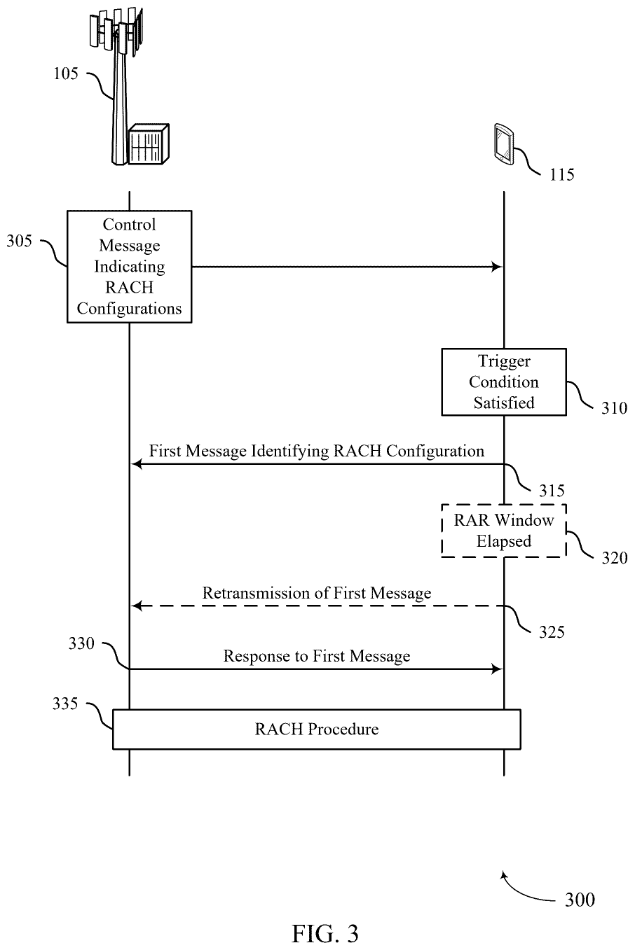

FIG. 3 shows an example of a process flow 300 that supports on-demand RACH procedure in accordance with one or more aspects of the present disclosure. The process flow 300 may implement or be implemented by aspects of the wireless communications system 100, the wireless communications system 200, or both as described with reference to FIGS. 1 and 2. For example, the process flow 300 may include a network entity 105 and a UE 115, which may be examples of corresponding devices as described with reference to FIGS. 1 and 2.

Alternative examples of the following may be implemented, where some operations are performed in a different order than described or are not performed at all. In some cases, operations may include additional features not mentioned below, or further operations may be added. Although the network entity 105 and the UE 115 are shown performing the operations of the process flow 300, some aspects of some operations may also be performed by one or more other wireless devices.

At 305, the network entity 105 may transmit a control message indicating RACH configurations. For example, the UE 115 may receive a control message indicating that a network entity 105 supports multiple RACH configurations. The control message may be an example of a SIB message (e.g., SIB1). The indication of the multiple RACH configurations in the control message may be an example of the on-demand RACH configuration indication 205 as described with reference to FIG. 2. For example, control message may include an on-demand RACH configuration corresponding to an on-demand RACH procedure by which the UE 115 may request that a first RACH configuration of the multiple RACH configurations be activated. That is, the multiple RACH configurations may include one or more deactivated RACH configurations.

In some examples, the on-demand RACH configuration may be associated with a first PRACH for on-demand random access, where the first PRACH is different than a second PRACH corresponding to a common RACH configuration of the multiple RACH configurations. In some examples, the on-demand RACH configuration and the common RACH configuration of the multiple RACH configurations may be associated with a same PRACH, and the on-demand RACH may be associated with a different set of preambles, ROs, or both than the common RACH configuration. The control message may include an indication of a mapping of one or more RACH resources to respective RACH configurations of the multiple RACH configurations.

At 310, the UE 115 may determine that a trigger condition is satisfied. The trigger condition may include a common RACH configuration being absent from one or more enabled RACH configurations. Additionally, or alternatively, the trigger condition may include a RACH configuration associated with a UE type being absent from the one or more enabled RACH configurations. The UE type may be an example of the UE type 220 as described with reference to FIG. 2.

At 315, the UE 115 may transmit a first message identifying a RACH configuration. For example, the UE 115 may transmit a first message including a first identifier of a first RACH configuration of the multiple RACH configurations based on the trigger condition for requesting activation of the first RACH configuration being satisfied at 310, the first RACH configuration being associated with a first RACH procedure. In some examples, the UE 115 may transmit the first message including the first identifier of the first RACH configuration, where the first RACH configuration is the common RACH configuration associated with a common RACH procedure. In some examples, the UE 115 may transmit the first message including the first identifier of the first RACH configuration, where the first RACH configuration includes the RACH configuration associated with the UE type corresponding to a RACH procedure for the UE type.

The first message identifying the RACH configuration may be an example of a message one (Msg1) of the on-demand RACH procedure. Additionally, or alternatively, the first message identifying the RACH configuration may be an example of the RACH configuration request 225 including the RACH configuration ID 230 and the preamble, RO, or both 235 as described with reference to FIG. 2. For example, the first message may indicate a preamble, an RO, or both corresponding to the first RACH configuration. In an example, the UE 115 may select a preamble, RO, or both, for Msg1 transmission, where the preamble, the RO, or both, may be selected to match the RACH configuration that the UE 115 is requesting.

At 320, the UE 115 may determine that an RAR window has elapsed. For example, the UE 115 may fail to receive a response to the first message within the RAR window (e.g., within the duration of the RAR window from transmission of the first message at 315). For example, the UE may not receive a message two (Msg2) response to Msg1 before an end of the RAR window, and the UE 115 may retransmit msg1 (e.g., the first message).

At 325, the UE 115 may transmit a retransmission of the first message. That is, the UE 115 may transmit a retransmission of the first message based on failure to receive the response to the first message within the RAR window.

At 330, the network entity 105 may transmit a response to the first message. For example, the UE 115 may receive a response to the first message, the response including the first identifier of the first RACH configuration to indicate the activation of the first RACH configuration responsive to the first message including the first identifier of the first RACH configuration. The response to the first message may be an example of Msg2 (e.g., a RAR message) of the on-demand RACH procedure. Additionally, or alternatively, the response to the first message may be an example of the RACH configuration response 240 as described with reference to FIG. 2. In some examples, the network entity 105 and the UE 115 may communicate the response to the first message in a search space associated with an on-demand RACH procedure. Additionally, or alternatively, the response may be scrambled via a common RNTI (e.g., such that one or more UEs different than the UE 115 may decode the response). In some examples, when a network entity 105 accepts the UE's requested RACH configuration, the network entity 105 may send back the ID of the requested RACH configuration in Msg2, where Msg2 may be sent in a search space specific for on-demand RACH configurations, scrambled by a common RNTI instead of the RA-RNTI, or both.

At 335, the network entity 105 and the UE 115 may perform the RACH procedure. That is, the network entity 105 and the UE 115 may perform the first RACH procedure associated with the first RACH configuration requested by the UE 115 at 315 (e.g., and, in some examples, retransmitted at 325) and activated by the network entity 105 via the response at 330.

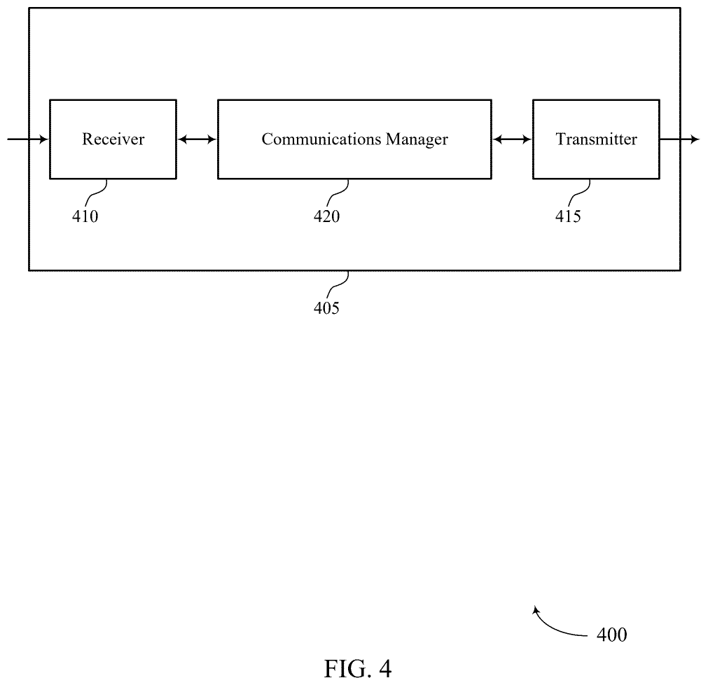

FIG. 4 shows a block diagram 400 of a device 405 that supports on-demand RACH procedure in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include one or more processors, memory coupled with the one or more processors, and instructions stored in the memory that are executable by the one or more processors to enable the one or more processors to perform the on-demand RACH procedure discussed herein. Each of these components may be in communication with one another (e.g., via one or more buses).

The receiver 410 may provide a means for receiving information such as packets, user data, control information, or any combination thereof associated with various information channels (e.g., control channels, data channels, information channels related to on-demand RACH procedure). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to on-demand RACH procedure). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of on-demand RACH procedure as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for receiving a control message indicating that a network entity supports a set of multiple RACH configurations. The communications manager 420 is capable of, configured to, or operable to support a means for transmitting a first message including a first identifier of a first RACH configuration of the set of multiple RACH configurations based on a trigger condition for requesting activation of the first RACH configuration being satisfied, the first RACH configuration being associated with a first RACH procedure. The communications manager 420 is capable of, configured to, or operable to support a means for receiving a response to the first message, the response including the first identifier of the first RACH configuration to indicate the activation of the first RACH configuration responsive to the first message including the first identifier of the first RACH configuration.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources.

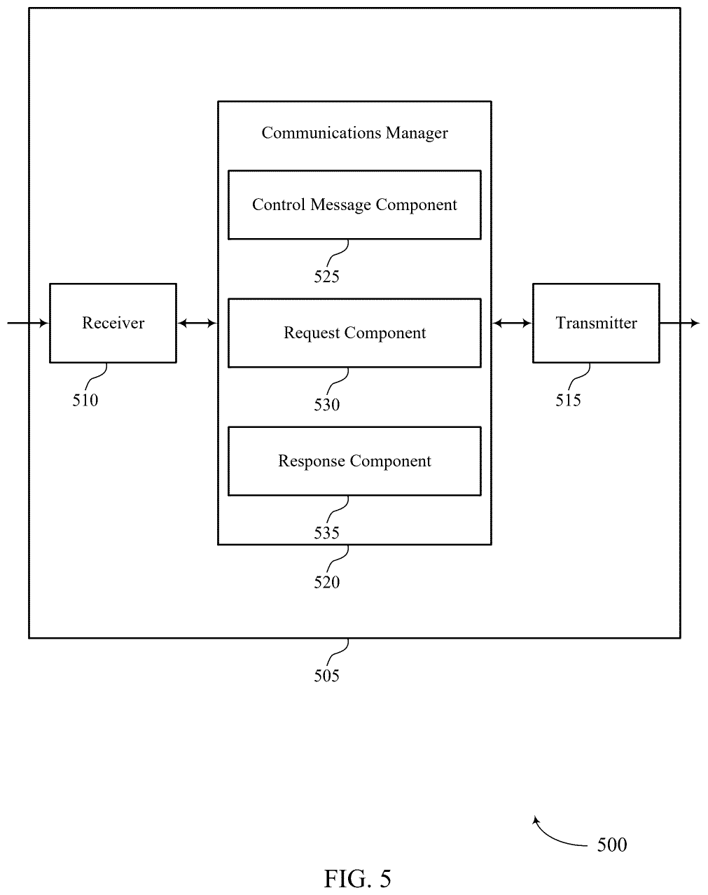

FIG. 5 shows a block diagram 500 of a device 505 that supports on-demand RACH procedure in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to on-demand RACH procedure). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to on-demand RACH procedure). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of on-demand RACH procedure as described herein. For example, the communications manager 520 may include a control message component 525, a request component 530, a response component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The control message component 525 is capable of, configured to, or operable to support a means for receiving a control message indicating that a network entity supports a set of multiple RACH configurations. The request component 530 is capable of, configured to, or operable to support a means for transmitting a first message including a first identifier of a first RACH configuration of the set of multiple RACH configurations based on a trigger condition for requesting activation of the first RACH configuration being satisfied, the first RACH configuration being associated with a first RACH procedure. The response component 535 is capable of, configured to, or operable to support a means for receiving a response to the first message, the response including the first identifier of the first RACH configuration to indicate the activation of the first RACH configuration responsive to the first message including the first identifier of the first RACH configuration.

In some cases, the control message component 525, request component 530, and the response component 535 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control message component 525, request component 530, and the response component 535 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

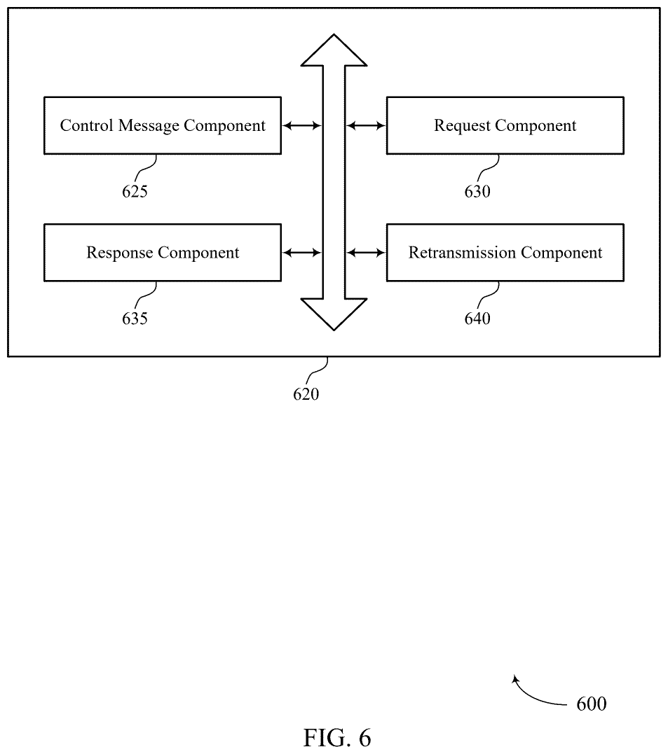

FIG. 6 shows a block diagram 600 of a communications manager 620 that supports on-demand RACH procedure in accordance with one or more aspects of the present disclosure. The communications manager 620 may be an example of aspects of a communications manager 420, a communications manager 520, or both, as described herein. The communications manager 620, or various components thereof, may be an example of means for performing various aspects of on-demand RACH procedure as described herein. For example, the communications manager 620 may include a control message component 625, a request component 630, a response component 635, a retransmission component 640, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The control message component 625 is capable of, configured to, or operable to support a means for receiving a control message indicating that a network entity supports a set of multiple RACH configurations. The request component 630 is capable of, configured to, or operable to support a means for transmitting a first message including a first identifier of a first RACH configuration of the set of multiple RACH configurations based on a trigger condition for requesting activation of the first RACH configuration being satisfied, the first RACH configuration being associated with a first RACH procedure. The response component 635 is capable of, configured to, or operable to support a means for receiving a response to the first message, the response including the first identifier of the first RACH configuration to indicate the activation of the first RACH configuration responsive to the first message including the first identifier of the first RACH configuration.

In some examples, the set of multiple RACH configurations include at least an on-demand RACH configuration, and where the first message, the response to the first message, or both are communicated in accordance with an on-demand RACH procedure corresponding to the on-demand RACH configuration.

In some examples, the on-demand RACH configuration is associated with a first physical RACH for on-demand random access. In some examples, the first physical RACH is different than a second physical RACH corresponding to a common RACH configuration of the set of multiple RACH configurations.

In some examples, the on-demand RACH configuration and a common RACH configuration of the set of multiple RACH configurations are associated with a same physical RACH, and the on-demand RACH configuration is associated with different set of preambles, ROs, or both than the common RACH configuration.

In some examples, to support transmitting the first message, the request component 630 is capable of, configured to, or operable to support a means for transmitting the first message including the first identifier of the first RACH configuration, where the first RACH configuration includes the common RACH configuration, the common RACH configuration being associated with a common RACH procedure.

In some examples, to support transmitting the first message, the request component 630 is capable of, configured to, or operable to support a means for transmitting the first message including the first identifier of the first RACH configuration, where the first RACH configuration includes the RACH configuration associated with the UE type, the RACH configuration being associated with a RACH procedure corresponding to the UE type.

In some examples, the first message indicates a preamble, a RO, or both, corresponding to the first RACH configuration.

In some examples, to support receiving the response to the first message, the response component 635 is capable of, configured to, or operable to support a means for receiving the response to the first message in a search space associated with an on-demand RACH procedure, and where the response is scrambled via a common RNTI.

In some examples, the retransmission component 640 is capable of, configured to, or operable to support a means for transmitting a retransmission of the first message based on failure to receive the response to the first message within a RAR window, where the response to the first message is received based on the retransmission of the first message.

In some examples, to support receiving the response to the first message, the response component 635 is capable of, configured to, or operable to support a means for receiving the response including the first identifier of the first RACH configuration to indicate the activation of the first RACH configuration, where the first RACH configuration includes, prior to receiving the response, a deactivated RACH configuration of the one or more deactivated RACH configurations.

In some examples, the control message further includes an indication of a mapping of one or more RACH resources to respective RACH configurations of the set of multiple RACH configurations.

In some examples, the control message includes an SIB message.

In some cases, the control message component 625, the request component 630, the response component 635, and the retransmission component 640 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control message component 625, the request component 630, the response component 635, and the retransmission component 640 discussed herein.

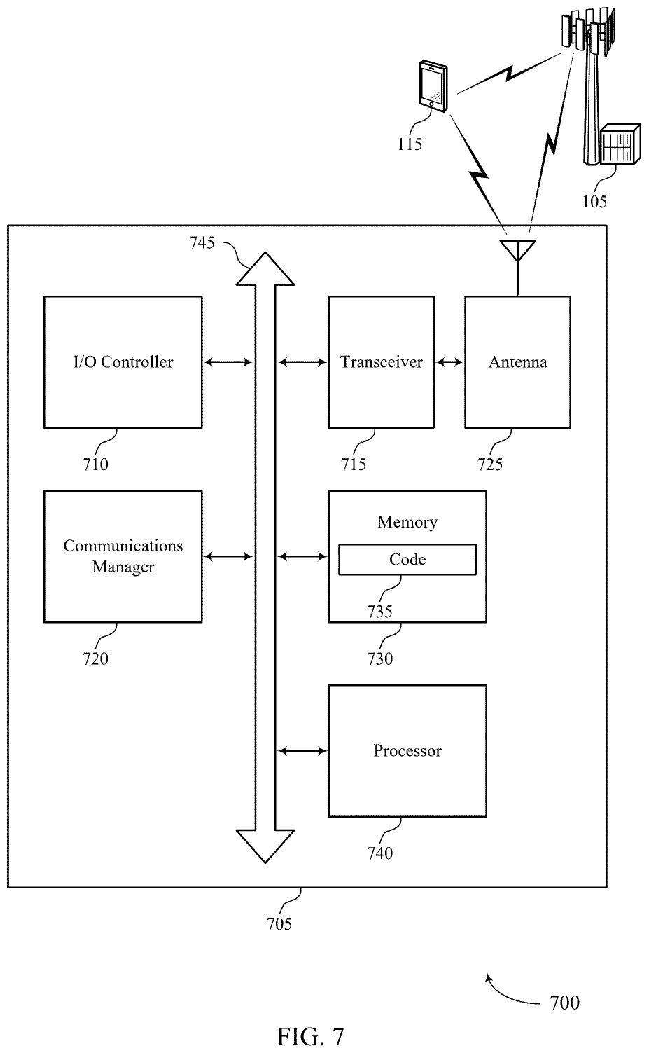

FIG. 7 shows a diagram of a system 700 including a device 705 that supports on-demand RACH procedure in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting on-demand RACH procedure). For example, the device 705 or a component of the device 705 may include at least one processor 740 and at least one memory 730 coupled with or to the at least one processor 740, the at least one processor 740 and the at least one memory 730 configured to perform various functions described herein. In some examples, the at least one processor 740 may include multiple processors, and the at least one memory 730 may include multiple memories. One or more of the multiple processors may be coupled with one or more of the multiple memories, which may, individually or collectively, be configured to perform various functions herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for receiving a control message indicating that a network entity supports a set of multiple RACH configurations. The communications manager 720 is capable of, configured to, or operable to support a means for transmitting a first message including a first identifier of a first RACH configuration of the set of multiple RACH configurations based on a trigger condition for requesting activation of the first RACH configuration being satisfied, the first RACH configuration being associated with a first RACH procedure. The communications manager 720 is capable of, configured to, or operable to support a means for receiving a response to the first message, the response including the first identifier of the first RACH configuration to indicate the activation of the first RACH configuration responsive to the first message including the first identifier of the first RACH configuration.

By including or configuring the communications manager 720 in accordance with examples as described herein, the device 705 may support techniques for reduced power consumption, more efficient utilization of communication resources, improved coordination between devices, and longer battery life.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of on-demand RACH procedure as described herein, or the at least one processor 740 and the at least one memory 730 may be otherwise configured to, individually or collectively, perform or support such operations.

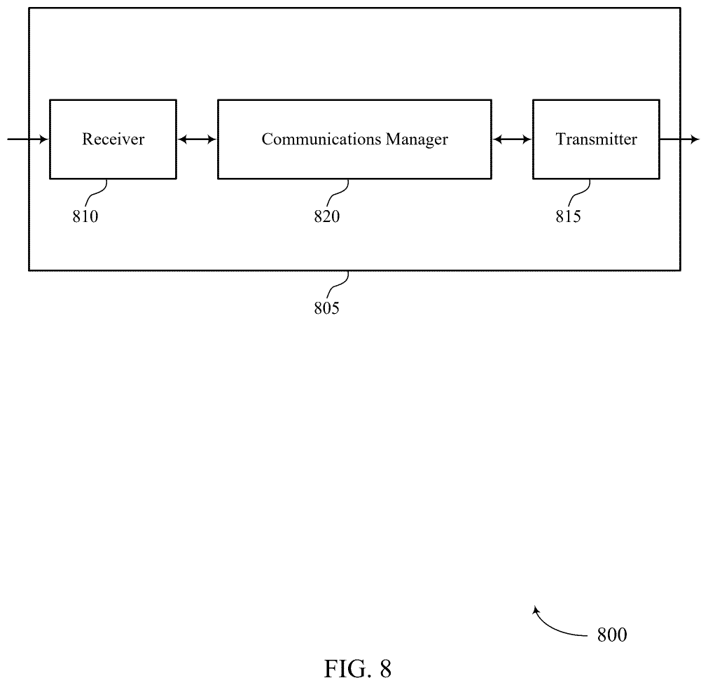

FIG. 8 shows a block diagram 800 of a device 805 that supports on-demand RACH procedure in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include one or more processors, memory coupled with the one or more processors, and instructions stored in the memory that are executable by the one or more processors to enable the one or more processors to perform the on-demand RACH procedure discussed herein. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of on-demand RACH procedure as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for transmitting a control message indicating that the network entity supports a set of multiple RACH configurations. The communications manager 820 is capable of, configured to, or operable to support a means for receiving a first message including a first identifier of a first RACH configuration of the set of multiple RACH configurations based on a trigger condition for requesting activation of the first RACH configuration being satisfied, the first RACH configuration being associated with a first RACH procedure. The communications manager 820 is capable of, configured to, or operable to support a means for transmitting a response to the first message, the response including the first identifier of the first RACH configuration to indicate the activation of the first RACH configuration responsive to the first message including the first identifier of the first RACH configuration.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources.

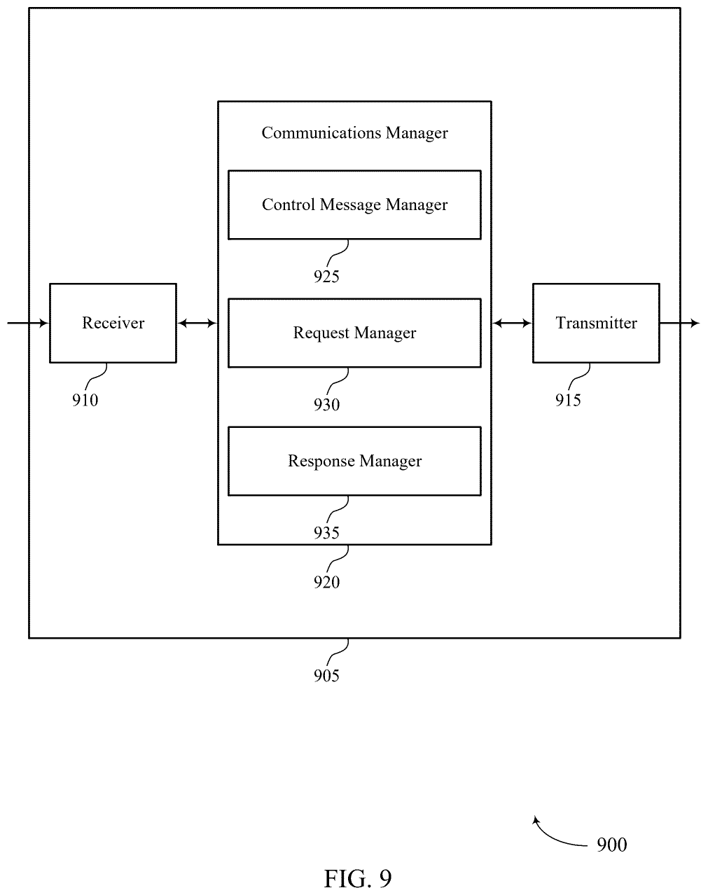

FIG. 9 shows a block diagram 900 of a device 905 that supports on-demand RACH procedure in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of on-demand RACH procedure as described herein. For example, the communications manager 920 may include a control message manager 925, a request manager 930, a response manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The control message manager 925 is capable of, configured to, or operable to support a means for transmitting a control message indicating that the network entity supports a set of multiple RACH configurations. The request manager 930 is capable of, configured to, or operable to support a means for receiving a first message including a first identifier of a first RACH configuration of the set of multiple RACH configurations based on a trigger condition for requesting activation of the first RACH configuration being satisfied, the first RACH configuration being associated with a first RACH procedure. The response manager 935 is capable of, configured to, or operable to support a means for transmitting a response to the first message, the response including the first identifier of the first RACH configuration to indicate the activation of the first RACH configuration responsive to the first message including the first identifier of the first RACH configuration.

In some cases, the control message manager 925, the request manager 930, and the response manager 935 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control message manager 925, the request manager 930, and the response manager 935 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

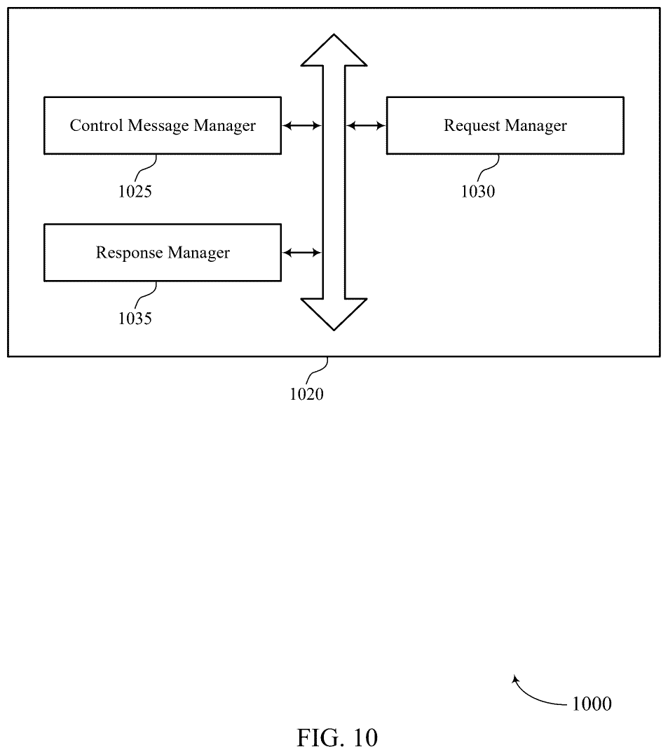

FIG. 10 shows a block diagram 1000 of a communications manager 1020 that supports on-demand RACH procedure in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of on-demand RACH procedure as described herein. For example, the communications manager 1020 may include a control message manager 1025, a request manager 1030, a response manager 1035, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication in accordance with examples as disclosed herein. The control message manager 1025 is capable of, configured to, or operable to support a means for transmitting a control message indicating that the network entity supports a set of multiple RACH configurations. The request manager 1030 is capable of, configured to, or operable to support a means for receiving a first message including a first identifier of a first RACH configuration of the set of multiple RACH configurations based on a trigger condition for requesting activation of the first RACH configuration being satisfied, the first RACH configuration being associated with a first RACH procedure. The response manager 1035 is capable of, configured to, or operable to support a means for transmitting a response to the first message, the response including the first identifier of the first RACH configuration to indicate the activation of the first RACH configuration responsive to the first message including the first identifier of the first RACH configuration.

In some examples, the set of multiple RACH configurations include at least an on-demand RACH configuration, and where the first message, the response to the first message, or both are communicated in accordance with an on-demand RACH procedure corresponding to the on-demand RACH configuration.

In some examples, the on-demand RACH configuration is associated with a first physical RACH for on-demand random access. In some examples, the first physical RACH is different than a second physical RACH corresponding to a common RACH configuration of the set of multiple RACH configurations.

In some examples, the on-demand RACH configuration and a common RACH configuration of the set of multiple RACH configurations are associated with a same physical RACH, and the on-demand RACH configuration is associated with different set of preambles, ROs, or both than the common RACH configuration.

In some examples, to support transmitting the response to the first message, the response manager 1035 is capable of, configured to, or operable to support a means for transmitting the response to the first message in a search space associated with an on-demand RACH procedure, and where the response is scrambled via a common RNTI.

In some examples, to support transmitting the response to the first message, the response manager 1035 is capable of, configured to, or operable to support a means for transmitting the response including the first identifier of the first RACH configuration to indicate the activation of the first RACH configuration, where the first RACH configuration includes, prior to receiving the response, a deactivated RACH configuration of the one or more deactivated RACH configurations.

In some examples, the control message further includes an indication of a mapping of one or more RACH resources to respective RACH configurations of the set of multiple RACH configurations.

In some cases, the control message manager 1025, the request manager 1030, and the response manager 1035 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control message manager 1025, the request manager 1030, and the response manager 1035 discussed herein.

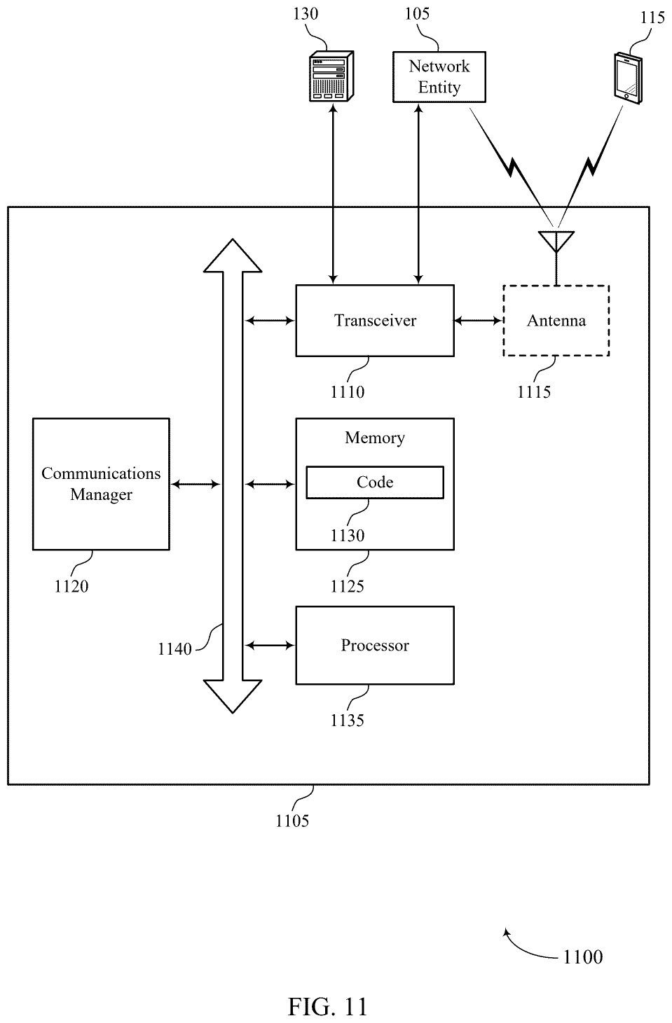

FIG. 11 shows a diagram of a system 1100 including a device 1105 that supports on-demand RACH procedure in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting on-demand RACH procedure). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors, and the at least one memory 1125 may include multiple memories. One or more of the multiple processors may be coupled with one or more of the multiple memories, which may, individually or collectively, be configured to perform various functions herein.

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 is capable of, configured to, or operable to support a means for transmitting a control message indicating that the network entity supports a set of multiple RACH configurations. The communications manager 1120 is capable of, configured to, or operable to support a means for receiving a first message including a first identifier of a first RACH configuration of the set of multiple RACH configurations based on a trigger condition for requesting activation of the first RACH configuration being satisfied, the first RACH configuration being associated with a first RACH procedure. The communications manager 1120 is capable of, configured to, or operable to support a means for transmitting a response to the first message, the response including the first identifier of the first RACH configuration to indicate the activation of the first RACH configuration responsive to the first message including the first identifier of the first RACH configuration.

By including or configuring the communications manager 1120 in accordance with examples as described herein, the device 1105 may support techniques for reduced power consumption, more efficient utilization of communication resources, improved coordination between devices, and longer battery life.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of on-demand RACH procedure as described herein, or the at least one processor 1135 and the at least one memory 1125 may be otherwise configured to, individually or collectively, perform or support such operations.

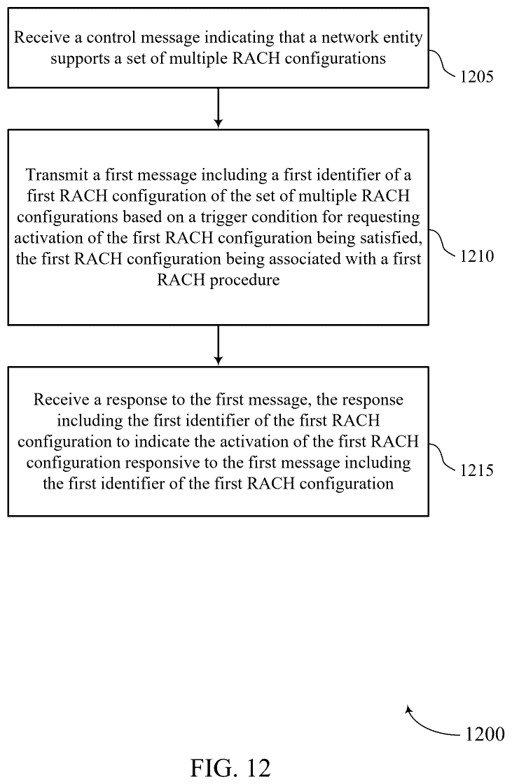

FIG. 12 shows a flowchart illustrating a method 1200 that supports on-demand RACH procedure in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a control message indicating that a network entity supports a set of multiple RACH configurations. The operations of 1205 may be performed in accordance with examples as disclosed herein. In some examples, aspects of the operations of 1205 may be performed by a control message component 625 as described with reference to FIG. 6.

At 1210, the method may include transmitting a first message including a first identifier of a first RACH configuration of the set of multiple RACH configurations based on a trigger condition for requesting activation of the first RACH configuration being satisfied, the first RACH configuration being associated with a first RACH procedure. The operations of 1210 may be performed in accordance with examples as disclosed herein. In some examples, aspects of the operations of 1210 may be performed by a request component 630 as described with reference to FIG. 6.

At 1215, the method may include receiving a response to the first message, the response including the first identifier of the first RACH configuration to indicate the activation of the first RACH configuration responsive to the first message including the first identifier of the first RACH configuration. The operations of 1215 may be performed in accordance with examples as disclosed herein. In some examples, aspects of the operations of 1215 may be performed by a response component 635 as described with reference to FIG. 6.

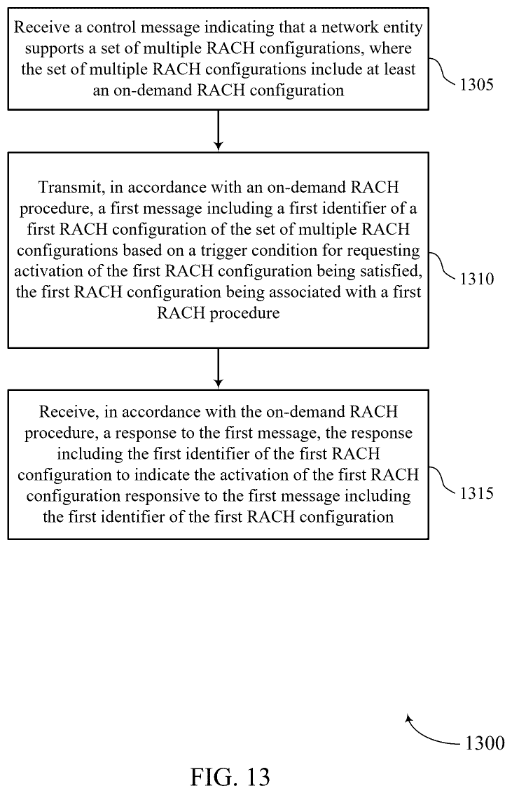

FIG. 13 shows a flowchart illustrating a method 1300 that supports on-demand RACH procedure in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a control message indicating that a network entity supports a set of multiple RACH configurations, where the set of multiple RACH configurations include at least an on-demand RACH configuration. The operations of 1305 may be performed in accordance with examples as disclosed herein. In some examples, aspects of the operations of 1305 may be performed by a control message component 625 as described with reference to FIG. 6.

At 1310, the method may include transmitting, in accordance with an on-demand RACH procedure, a first message including a first identifier of a first RACH configuration of the set of multiple RACH configurations based on a trigger condition for requesting activation of the first RACH configuration being satisfied, the first RACH configuration being associated with a first RACH procedure. The operations of 1310 may be performed in accordance with examples as disclosed herein. In some examples, aspects of the operations of 1310 may be performed by a request component 630 as described with reference to FIG. 6.

At 1315, the method may include receiving, in accordance with the on-demand RACH procedure, a response to the first message, the response including the first identifier of the first RACH configuration to indicate the activation of the first RACH configuration responsive to the first message including the first identifier of the first RACH configuration. The operations of 1315 may be performed in accordance with examples as disclosed herein. In some examples, aspects of the operations of 1315 may be performed by a response component 635 as described with reference to FIG. 6.

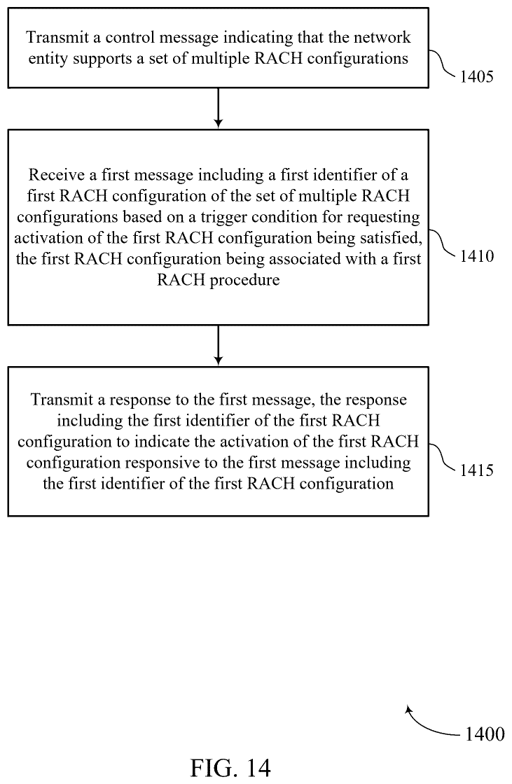

FIG. 14 shows a flowchart illustrating a method 1400 that supports on-demand RACH procedure in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a control message indicating that the network entity supports a set of multiple RACH configurations. The operations of 1405 may be performed in accordance with examples as disclosed herein. In some examples, aspects of the operations of 1405 may be performed by a control message manager 1025 as described with reference to FIG. 10.

At 1410, the method may include receiving a first message including a first identifier of a first RACH configuration of the set of multiple RACH configurations based on a trigger condition for requesting activation of the first RACH configuration being satisfied, the first RACH configuration being associated with a first RACH procedure. The operations of 1410 may be performed in accordance with examples as disclosed herein. In some examples, aspects of the operations of 1410 may be performed by a request manager 1030 as described with reference to FIG. 10.

At 1415, the method may include transmitting a response to the first message, the response including the first identifier of the first RACH configuration to indicate the activation of the first RACH configuration responsive to the first message including the first identifier of the first RACH configuration. The operations of 1415 may be performed in accordance with examples as disclosed herein. In some examples, aspects of the operations of 1415 may be performed by a response manager 1035 as described with reference to FIG. 10.

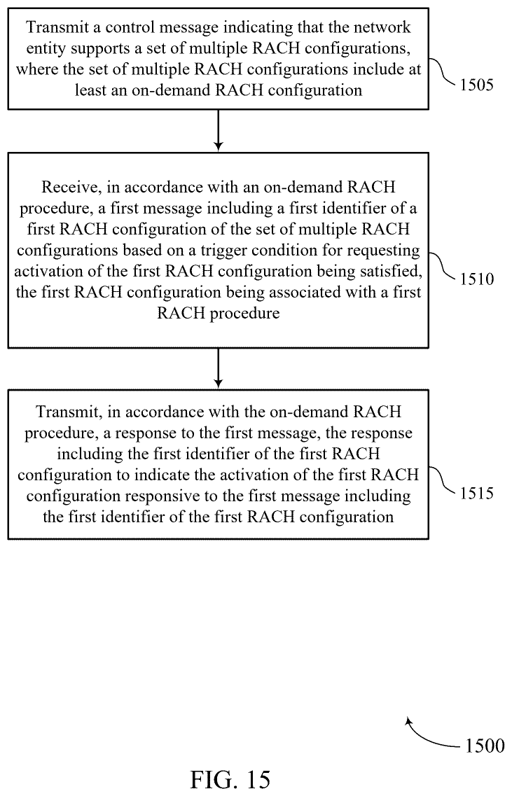

FIG. 15 shows a flowchart illustrating a method 1500 that supports on-demand RACH procedure in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a control message indicating that the network entity supports a set of multiple RACH configurations, where the set of multiple RACH configurations include at least an on-demand RACH configuration. The operations of 1505 may be performed in accordance with examples as disclosed herein. In some examples, aspects of the operations of 1505 may be performed by a control message manager 1025 as described with reference to FIG. 10.

At 1510, the method may include receiving, in accordance with an on-demand RACH procedure, a first message including a first identifier of a first RACH configuration of the set of multiple RACH configurations based on a trigger condition for requesting activation of the first RACH configuration being satisfied, the first RACH configuration being associated with a first RACH procedure. The operations of 1510 may be performed in accordance with examples as disclosed herein. In some examples, aspects of the operations of 1510 may be performed by a request manager 1030 as described with reference to FIG. 10.

At 1515, the method may include transmitting, in accordance with the on-demand RACH procedure, a response to the first message, the response including the first identifier of the first RACH configuration to indicate the activation of the first RACH configuration responsive to the first message including the first identifier of the first RACH configuration. The operations of 1515 may be performed in accordance with examples as disclosed herein. In some examples, aspects of the operations of 1515 may be performed by a response manager 1035 as described with reference to FIG. 10.

The following provides an overview of aspects of the present disclosure:

Aspect 1: A method for wireless communication by a UE, comprising: receiving a control message indicating that a network entity supports a plurality of RACH configurations; transmitting a first message comprising a first identifier of a first RACH configuration of the plurality of RACH configurations based at least in part on a trigger condition for requesting activation of the first RACH configuration being satisfied, the first RACH configuration being associated with a first RACH procedure; and receiving a response to the first message, the response comprising the first identifier of the first RACH configuration to indicate the activation of the first RACH configuration responsive to the first message comprising the first identifier of the first RACH configuration.

Aspect 2: The method of aspect 1, wherein the plurality of RACH configurations comprise at least an on-demand RACH configuration, and wherein the first message, the response to the first message, or both are communicated in accordance with an on-demand RACH procedure corresponding to the on-demand RACH configuration.

Aspect 3: The method of aspect 2, wherein the on-demand RACH configuration is associated with a first PRACH for on-demand random access, the first PRACH is different than a second PRACH corresponding to a common RACH configuration of the plurality of RACH configurations.

Aspect 4: The method of any of aspects 2 through 3, wherein the on-demand RACH configuration and a common RACH configuration of the plurality of RACH configurations are associated with a same PRACH, and the on-demand RACH configuration is associated with different set of preambles, ROs, or both than the common RACH configuration.

Aspect 5: The method of any of aspects 1 through 4, wherein the trigger condition comprises a common RACH configuration being absent from one or more enabled RACH configurations, and wherein transmitting the first message comprises: transmitting the first message comprising the first identifier of the first RACH configuration, wherein the first RACH configuration comprises the common RACH configuration, the common RACH configuration being associated with a common RACH procedure.

Aspect 6: The method of any of aspects 1 through 5, wherein the trigger condition comprises a RACH configuration associated with a UE type being absent from one or more enabled RACH configurations, and wherein transmitting the first message comprises: transmitting the first message comprising the first identifier of the first RACH configuration, wherein the first RACH configuration comprises the RACH configuration associated with the UE type, the RACH configuration being associated with a RACH procedure corresponding to the UE type.

Aspect 7: The method of any of aspects 1 through 6, wherein the first message indicates a preamble, a RO, or both, corresponding to the first RACH configuration.

Aspect 8: The method of any of aspects 1 through 7, wherein receiving the response to the first message further comprises: receiving the response to the first message in a search space associated with an on-demand RACH procedure, and wherein the response is scrambled via a common RNTI.

Aspect 9: The method of any of aspects 1 through 8, further comprising: transmitting a retransmission of the first message based at least in part on failure to receive the response to the first message within a RAR window, wherein the response to the first message is received based at least in part on the retransmission of the first message.

Aspect 10: The method of any of aspects 1 through 9, wherein the plurality of RACH configurations comprise one or more deactivated RACH configurations, and wherein receiving the response to the first message further comprises: receiving the response comprising the first identifier of the first RACH configuration to indicate the activation of the first RACH configuration, wherein the first RACH configuration comprises, prior to receiving the response, a deactivated RACH configuration of the one or more deactivated RACH configurations.

Aspect 11: The method of any of aspects 1 through 10, wherein the control message further comprises an indication of a mapping of one or more RACH resources to respective RACH configurations of the plurality of RACH configurations.

Aspect 12: The method of any of aspects 1 through 11, wherein the control message comprises an SIB message.

Aspect 13: A method for wireless communication by a network entity, comprising: transmitting a control message indicating that the network entity supports a plurality of RACH configurations; receiving a first message comprising a first identifier of a first RACH configuration of the plurality of RACH configurations based at least in part on a trigger condition for requesting activation of the first RACH configuration being satisfied, the first RACH configuration being associated with a first RACH procedure; and transmitting a response to the first message, the response comprising the first identifier of the first RACH configuration to indicate the activation of the first RACH configuration responsive to the first message comprising the first identifier of the first RACH configuration.

Aspect 14: The method of aspect 13, wherein the plurality of RACH configurations comprise at least an on-demand RACH configuration, and wherein the first message, the response to the first message, or both are communicated in accordance with an on-demand RACH procedure corresponding to the on-demand RACH configuration.

Aspect 15: The method of aspect 14, wherein the on-demand RACH configuration is associated with a first PRACH for on-demand random access, the first PRACH is different than a second PRACH corresponding to a common RACH configuration of the plurality of RACH configurations.

Aspect 16: The method of any of aspects 14 through 15, wherein the on-demand RACH configuration and a common RACH configuration of the plurality of RACH configurations are associated with a same PRACH, and the on-demand RACH configuration is associated with different set of preambles, ROs, or both than the common RACH configuration.

Aspect 17: The method of any of aspects 13 through 16, wherein transmitting the response to the first message further comprises: transmitting the response to the first message in a search space associated with an on-demand RACH procedure, and wherein the response is scrambled via a common RNTI.

Aspect 18: The method of any of aspects 13 through 17, wherein the plurality of RACH configurations comprise one or more deactivated RACH configurations, and wherein transmitting the response to the first message further comprises: transmitting the response comprising the first identifier of the first RACH configuration to indicate the activation of the first RACH configuration, wherein the first RACH configuration comprises, prior to receiving the response, a deactivated RACH configuration of the one or more deactivated RACH configurations.

Aspect 19: The method of any of aspects 13 through 18, wherein the control message further comprises an indication of a mapping of one or more RACH resources to respective RACH configurations of the plurality of RACH configurations.

Aspect 20: A UE for wireless communication, comprising one or more memories storing processor-executable code, and one or more processors coupled with the one or more memories and individually or collectively operable to execute the code to cause the UE to perform a method of any of aspects 1 through 12.

Aspect 21: A UE for wireless communication, comprising at least one means for performing a method of any of aspects 1 through 12.

Aspect 22: A non-transitory computer-readable medium storing code for wireless communication, the code comprising instructions executable by one or more processors to perform a method of any of aspects 1 through 12.

Aspect 23: A network entity for wireless communication, comprising one or more memories storing processor-executable code, and one or more processors coupled with the one or more memories and individually or collectively operable to execute the code to cause the network entity to perform a method of any of aspects 13 through 19.

Aspect 24: A network entity for wireless communication, comprising at least one means for performing a method of any of aspects 13 through 19.

Aspect 25: A non-transitory computer-readable medium storing code for wireless communication, the code comprising instructions executable by one or more processors to perform a method of any of aspects 13 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

Any functions or operations described herein as being capable of being performed by a processor may be performed by multiple processors that, individually or collectively, are capable of performing the described functions or operations. For example, the functions described herein may be performed by multiple processors, each tasked with at least a subset of the described functions, such that, collectively, the multiple processors perform all of the described functions. As such, the described functions can be performed by a single processor or a group of processors functioning together (i.e., collectively) to perform the described functions, where any one processor performs at least a subset of the described functions.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

Any functions or operations described herein as being capable of being performed by a processor may be performed by multiple processors that, individually or collectively, are capable of performing the described functions or operations. For example, the functions described herein may be performed by multiple processors, each tasked with at least a subset of the described functions, such that, collectively, the multiple processors perform all of the described functions. As such, the described functions can be performed by a single processor or a group of processors functioning together (i.e., collectively) to perform the described functions, where any one processor performs at least a subset of the described functions.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. ”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components. ”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message indicating that a network entity supports a plurality of random access channel configurations;
transmit a first message comprising a first identifier of a first random access channel configuration of the plurality of random access channel configurations based at least in part on a trigger condition for requesting activation of the first random access channel configuration being satisfied, the first random access channel configuration being associated with a first random access channel procedure; and
receive a response to the first message, the response comprising the first identifier of the first random access channel configuration to indicate the activation of the first random access channel configuration responsive to the first message comprising the first identifier of the first random access channel configuration.

2. The UE of claim 1, wherein the plurality of random access channel configurations comprise at least an on-demand random access channel configuration, and wherein the first message, the response to the first message, or both are communicated in accordance with an on-demand random access channel procedure corresponding to the on-demand random access channel configuration.

3. The UE of claim 2, wherein:
the on-demand random access channel configuration is associated with a first physical random access channel for on-demand random access, and
the first physical random access channel is different than a second physical random access channel corresponding to a common random access channel configuration of the plurality of random access channel configurations.

4. The UE of claim 2, wherein the on-demand random access channel configuration and a common random access channel configuration of the plurality of random access channel configurations are associated with a same physical random access channel, and the on-demand random access channel configuration is associated with different set of preambles, random access channel occasions, or both than the common random access channel configuration.

5. The UE of claim 1, wherein the trigger condition comprises a common random access channel configuration being absent from one or more enabled random access channel configurations, and wherein, to transmit the first message, the one or more processors are individually or collectively operable to execute the code to cause the UE to:
transmit the first message comprising the first identifier of the first random access channel configuration, wherein the first random access channel configuration comprises the common random access channel configuration, the common random access channel configuration being associated with a common random access channel procedure.

6. The UE of claim 1, wherein the trigger condition comprises a random access channel configuration associated with a UE type being absent from one or more enabled random access channel configurations, and wherein, to transmit the first message, the one or more processors are individually or collectively operable to execute the code to cause the UE to:
transmit the first message comprising the first identifier of the first random access channel configuration, wherein the first random access channel configuration comprises the random access channel configuration associated with the UE type, the random access channel configuration being associated with a random access channel procedure corresponding to the UE type.

7. The UE of claim 1, wherein the first message indicates a preamble, a random access channel occasion, or both, corresponding to the first random access channel configuration.

8. The UE of claim 1, wherein, to receive the response to the first message, the one or more processors are individually or collectively further operable to execute the code to cause the UE to:
receive the response to the first message in a search space associated with an on-demand random access channel procedure, and wherein the response is scrambled via a common radio network temporary identifier (RNTI).

9. The UE of claim 1, wherein the one or more processors are individually or collectively further operable to execute the code to cause the UE to:
transmit a retransmission of the first message based at least in part on failure to receive the response to the first message within a random access response (RAR) window, wherein the response to the first message is received based at least in part on the retransmission of the first message.

10. The UE of claim 1, wherein the plurality of random access channel configurations comprise one or more deactivated random access channel configurations, and wherein, to receive the response to the first message, the one or more processors are individually or collectively further operable to execute the code to cause the UE to:
receive the response comprising the first identifier of the first random access channel configuration to indicate the activation of the first random access channel configuration, wherein the first random access channel configuration comprises, prior to receiving the response, a deactivated random access channel configuration of the one or more deactivated random access channel configurations.

11. The UE of claim 1, wherein the control message further comprises an indication of a mapping of one or more random access channel resources to respective random access channel configurations of the plurality of random access channel configurations.

12. The UE of claim 1, wherein the control message comprises a system information block (SIB) message.

13. A network entity, comprising:
one or more memories storing processor-executable code; and
one or more processors coupled with the one or more memories and individually or collectively operable to execute the code to cause the network entity to:
transmit a control message indicating that the network entity supports a plurality of random access channel configurations;
receive a first message comprising a first identifier of a first random access channel configuration of the plurality of random access channel configurations based at least in part on a trigger condition for requesting activation of the first random access channel configuration being satisfied, the first random access channel configuration being associated with a first random access channel procedure; and
transmit a response to the first message, the response comprising the first identifier of the first random access channel configuration to indicate the activation of the first random access channel configuration responsive to the first message comprising the first identifier of the first random access channel configuration.

14. The network entity of claim 13, wherein the plurality of random access channel configurations comprise at least an on-demand random access channel configuration, and wherein the first message, the response to the first message, or both are communicated in accordance with an on-demand random access channel procedure corresponding to the on-demand random access channel configuration.

15. The network entity of claim 14, wherein:
the on-demand random access channel configuration is associated with a first physical random access channel for on-demand random access, and
the first physical random access channel is different than a second physical random access channel corresponding to a common random access channel configuration of the plurality of random access channel configurations.

16. The network entity of claim 14, wherein the on-demand random access channel configuration and a common random access channel configuration of the plurality of random access channel configurations are associated with a same physical random access channel, and the on-demand random access channel configuration is associated with different set of preambles, random access channel occasions, or both than the common random access channel configuration.

17. The network entity of claim 13, wherein, to transmit the response to the first message, the one or more processors are individually or collectively further operable to execute the code to cause the network entity to:
transmit the response to the first message in a search space associated with an on-demand random access channel procedure, and wherein the response is scrambled via a common radio network temporary identifier (RNTI).

18. The network entity of claim 13, wherein the plurality of random access channel configurations comprise one or more deactivated random access channel configurations, and wherein, to transmit the response to the first message, the one or more processors are individually or collectively further operable to execute the code to cause the network entity to:
transmit the response comprising the first identifier of the first random access channel configuration to indicate the activation of the first random access channel configuration, wherein the first random access channel configuration comprises, prior to receiving the response, a deactivated random access channel configuration of the one or more deactivated random access channel configurations.

19. The network entity of claim 13, wherein the control message further comprises an indication of a mapping of one or more random access channel resources to respective random access channel configurations of the plurality of random access channel configurations.

20. A method for wireless communication by a user equipment (UE), comprising:
receiving a control message indicating that a network entity supports a plurality of random access channel configurations;
transmitting a first message comprising a first identifier of a first random access channel configuration of the plurality of random access channel configurations based at least in part on a trigger condition for requesting activation of the first random access channel configuration being satisfied, the first random access channel configuration being associated with a first random access channel procedure; and
receiving a response to the first message, the response comprising the first identifier of the first random access channel configuration to indicate the activation of the first random access channel configuration responsive to the first message comprising the first identifier of the first random access channel configuration.
